(19) United States
(12) Patent Application Publication
(10) Pub. No.: US 2003/0050428 A1
(43) Pub. Date: Mar. 13, 2003

(54) Method for impoving the adhesion stability of the surface of moulded parts consisting of synthetic material

(76) Inventors: Karsten Reihs, Koln (DE); Matthias Voetz, Koln (DE); Harald Fuchs, Nottuln (DE); Christian Seidel, Seelze (DE); Marcus Schafer, Munster (DE); Heiko Kopf, Altenberge (DE)

Correspondence Address: BAYER CORPORATION, PATENT DEPARTMENT, 100 BAYER ROAD, PITTSBURGH, PA, 15205, US

(21) Appl. No.: 10/221,966

(22) PCT Filed: Mar. 9, 2001
(86) PCT No.: PCT/EP01/02683

(30) Foreign Application Priority Data
Mar. 22, 2000 (DE) 100 14 030.0

(51) Int. Cl. C08G 64/00; C08J 3/00

(52) U.S. Cl. 528/196; 528/480

(57) ABSTRACT

The invention relates to a method for improving the adhesion stability of the surface of moulded parts consisting of synthetic material, especially polycarbonate.

The invention relates to a process for improving the adhesive stability of the surface of plastic mouldings, in particular of polycarbonate mouldings.

Polycarbonates can be produced in accordance with known processes. Suitable processes for producing polycarbonates are, for example, the production from bisphenols with phosgene in accordance with the phase-interface process or from bisphenols with phosgene in accordance with the process in homogeneous phase, the so-called pyridine process, or from bisphenols with carbonic esters in accordance with the melt transesterification process. These production processes are described in, for example, H. Schnell, “Chemistry and Physics of Polycarbonates”, Polymer Reviews, Volume 9, pp 31-76, Interscience Publishers, New York, London, Sydney, 1964. The stated production processes are also described in D. Freitag, U. Grigo, P. R. Müller, H. Nouvertne, “Polycarbonates” in Encyclopedia of Polymer Science and Engineering, Volume 11, Second Edition, 1988, pages 648 to 718 and in U. Grigo, K. Kircher and P. R. Müller, “Polycarbonate” in Becker, Braun, Kunststoff-Handbuch, Volume 3/1, Polycarbonate, Polyacetale, Polyester, Celluloseester, Carl Hanser Verlag München, Vienna 1992, pages 117 to 299.

The melt transesterification process is described, in particular, in H. Schnell, “Chemistry and Physics of Polycarbonates”, Polymer Reviews, Volume 9, pp 44 to 51, Interscience Publishers, New York, London, Sydney, 1964 and also in DE-A 1 031 512, in U.S. Pat. No. 3,022,272, in U.S. Pat. No. 5,340,905 and in U.S. Pat. No. 5,399,659.

Raw materials and auxiliary substances having a low degree of impurities are preferably employed in the production of polycarbonate. Particularly in the production according to the melt transesterification process, the bisphenols that are employed and the carbonic-acid derivatives that are employed should be as free as possible from alkali ions and alkaline-earth ions. Such pure raw materials can be obtained by, for example, the carbonic-acid derivatives, for example carbonic esters, and the bisphenols being recrystallised, washed or distilled.

In the production of polycarbonates in accordance with the melt transesterification process the reaction of the bisphenol and the carbonic diester can be carried out continuously or discontinuously, for example in stirrer vessels, thin-film evaporators, falling-film evaporators, cascades of stirrer vessels, extruders, kneaders, simple disc-type reactors and high-viscosity disc-type reactors.

In order to be better able to subject the strongly hygroscopic polycarbonate that has been produced in this way to further processing, it is often granulated immediately following its production.

The polycarbonate granulate can be processed into semifinished products or mouldings of all kinds, in accordance with likewise known processes. Extrusion processes, injection-moulding processes and extrusion blow-moulding processes may be mentioned as examples of processing techniques. By way of examples of semifinished products, mention may be made of films, solid sheets, twin-wall sheets, profiles and tubes. Such polycarbonates can be employed for the most diverse purposes. They are used in electrical engineering, in automotive engineering, in the construction industry or in data storage.

Now if polycarbonate mouldings have to be vapour-coated with a metallic film with a view to the their subsequent use, as optical data carriers for example, the surface of the moulding has to be specially treated in order to improve the adhesion between the applied metallic film and the moulding.

It has been discovered that intercalated (dissolved) water that is contained in the polymer granulate leads to problems in the course of coating the mouldings produced therefrom, since the adhesive stability, particularly in the case of a water content that is variably distributed over the surface, is too low for optimal adhesion of the metallic film.

The object underlying the invention is therefore to obtain an improvement in the adhesive stability of the surface of plastic mouldings, in order to optimise the adhesion in connection with the subsequent application of a metallic film.

In accordance with the invention this object is achieved, in a first process, by the proportion of the intercalated water in the granulate being adjusted already in the course of granulation.

Alternatively, the invention provides for adjusting the proportion of the intercalated water in the semifinished product. The proportion of intercalated water preferably amounts to less than 0.01% (100 ppm).

In order that the polycarbonate granulate likewise retains or exhibits a certain water content after the polymerisation, a further development of the invention provides for bringing the granulate or the semifinished product to a certain temperature. By heating up the granulate or the semifinished product, a defined and uniformly distributed proportion of water can be obtained, so that the mouldings produced from such a granulate or semifinished product are optimised with respect to their water content, in order to guarantee a flawless subsequent coating.

Now in order that the granulate or semifinished product exhibiting an adjusted proportion of water cannot be altered in its properties by environmental influences such as atmospheric moisture or such like until the time when mouldings are produced, a further teaching of the invention provides that the granulate or the semifinished product is stored in hermetically sealed manner until the time when mouldings are produced.

If the airtight packaging of a granulate or semifinished product that has been stored in this way is opened only a short time before the production of mouldings, this ensures that the mouldings produced from said granulate or semifinished product exhibit adequate adhesive stability in order to guarantee a reliable adhesion between moulding and metallic coating film.

In order to examine to what extent the storage of polycarbonate at various degrees of moisture is relevant to the adhesive properties, PC pieces with a size of 1.5 cm×1.5 cm were stored for 14 days under certain degrees of moisture. Subsequently an aluminium film with a thickness of 200 nm was applied onto the samples in a high-vacuum evaporation unit. Thereupon a lattice was carved into the metallised side with a scalpel. In order to guarantee the same grid size, this was done with the aid of a mask in which strips had been milled at a spacing of 1.5 mm.

The 15-mm-wide adhesive tape that was now applied (tesa Document-Film 57300-00000, Beiersdorf) is peeled off at an angle of 180° and with a constant force of 7.5 N. Only the sample that had been stored at 0% atmospheric moisture (in the Exikator with blue gel) showed no or only very slight detachment of the aluminium film. In the case of the remaining samples (24% and 100% atmospheric moisture) the aluminium film is almost totally detached. In the sample that had been stored at 24% atmospheric moisture a residual water content of 0.4% was determined by weighing; in the case of the sample that had been stored at 100% atmospheric moisture the residual water content amounted to 2.8%.

The heating of a PC sample with a water content of 1.5% to 140° C. over a period of 4 h lowers the water content to such an extent (0.1%) that good adhesion can subsequently be achieved.

Storage subject to exclusion of moisture and under drying agent again reduces the water content in the case of the granulate or even in the case of the semifinished product to such an extent that good adhesion can be achieved, as could be established in an experiment with a PC sheet that was stored for 14 days in the Exikator with blue gel.

Now the invention provides for avoiding this additional process step, namely the repeated expulsion of the water content in the hygroscopic granulate or semifinished product immediately prior to the production of mouldings, by the proportion of the intercalated water being reduced to such an extent already in the course of the production of granulate or in the course of the production of semifinished product that—given appropriate storage of the granulate or semifinished product—an additional drying prior to the production of mouldings is no longer required.

1. A process for improving the adhesive stability of the surface of plastic mouldings, in particular of polycarbonate mouldings, characterised in that the proportion of the intercalated water in the granulate is adjusted already in the course of granulation.

2. A process for improving the adhesive stability of the surface of plastic mouldings, in particular of polycarbonate mouldings, characterised in that the proportion of the intercalated water is adjusted in the semifinished product.

3. Process according to claim 1 or 2, characterised in that the proportion of intercalated water in the granulate or in the semifinished product is less than 0.01% (100 ppm).

4. Process according to any one of claims 1 to 3, characterised in that the proportion of water is adjusted by bringing the granulate or the semifinished product to a certain temperature.

5. Process according to any one of claims 1 to 4, characterised in that the granulate or semifinished product is stored in hermetically sealed manner until the time when mouldings are produced.
